(19) United States
(12) Patent Application Publication
(10) Pub. No.: US 2023/0241955 A1
(43) Pub. Date: Aug. 3, 2023

(54) FRONT/REAR-WHEEL INDEPENDENT DRIVE VEHICLE

(71) Applicant: TOYOTA JIDOSHA KABUSHIKI KAISHA, Toyota-shi (JP)

(72) Inventors: Koichi OKUDA, Toyota-shi (JP); Naoki ITAZU, Nagoya-shi (JP); Satoshi KASAMAI, Miyoshi-shi (JP)

(73) Assignee: TOYOTA JIDOSHA KABUSHIKI KAISHA, Toyota-shi (JP)

(21) Appl. No.: 18/094,755

(22) Filed: Jan. 9, 2023

(30) Foreign Application Priority Data
Jan. 12, 2022 (JP) 2022-003339

(51) Int. Cl. B60K 1/02; B60L 15/20

(52) U.S. Cl. CPC B60K 1/02; B60L 15/20; B60K 2001/001

(57) ABSTRACT

A front/rear-wheel independent drive vehicle includes: (a) a front-wheel drive unit including a front-side drive source configured to drive a front wheel of the vehicle and a front-side transmission mechanism disposed in a power transmission path between the front-side drive source and the front wheel and having a constant gear ratio; and (b) a rear-wheel drive unit including a rear-side drive source configured to drive a rear wheel of the vehicle and a rear-side transmission mechanism disposed in a power transmission path between the rear-side drive source and the rear wheel and having a constant gear ratio. The front-wheel drive unit and the rear-wheel drive unit are spaced apart from each other in a longitudinal direction of the vehicle. The gear ratio of the rear-side transmission mechanism is higher than the gear ratio of the front-side transmission mechanism.

This application claims priority from Japanese Patent Application No. 2022-003339 filed on Jan. 12, 2022, the disclosure of which is herein incorporated by reference in its entirety.

### FIELD OF THE INVENTION

The present invention relates to a front/rear-wheel independent drive vehicle including a front-side drive source configured to drive a front wheel of the vehicle; a front-side gear transmission mechanism, a rear-side drive source configured to drive a rear wheel of the vehicle, and a rear-side gear transmission mechanism, wherein a combination of the front-side drive source and the front-side gear transmission mechanism and a combination of the rear-side drive source and the rear-side gear transmission mechanism are provided independently of each other.

### BACKGROUND OF THE INVENTION

There is known a drive apparatus for a vehicle, which includes (a) a left-side drive unit including a left-side drive source configured to drive a left wheel of the vehicle and a left-side transmission mechanism and (b) a right-side drive unit including a right-side drive source configured to drive a right wheel of the vehicle and a right-side transmission mechanism, (c) wherein the drive apparatus is configured to drive one of the front and rear wheel. JP-H05-162542A discloses an example of such a drive apparatus, and proposes to make the left-side and right-side transmission mechanisms different from each other in terms of the gear ratio, for suppressing NV (Noise and Vibration). JP-2014-84102A discloses a front/rear-wheel independent drive vehicle including (a) a front-wheel drive unit including a front-side drive source configured to drive the front wheel and a front-side transmission mechanism, and (b) a rear-wheel drive unit including a rear-side drive source configured to drive the rear wheel and a rear-side transmission mechanism, wherein the front-wheel drive unit and the rear-wheel drive unit are provided independently of each other.

### SUMMARY OF THE INVENTION

In the above-described front/rear-wheel independent drive vehicle, too, there is a need to suppress the NV. It might be possible to employ an arrangement in which the front-side and rear-side transmission mechanisms (that are disposed to be separated from each other in a longitudinal direction of the vehicle) are made different from each other in terms of the gear ratio, although this arrangement is not yet known. However, where the gear ratios of the respective front-side and rear-side transmission mechanisms are different from each other, drive torques of the front and rear wheels are likely to be changed thereby possibly affecting drivability such as acceleration performance, so that it is a problem how to set the gear ratios of the respective front-side and rear-side transmission mechanisms.

The present invention was made in view of the background art described above. It is therefore an object of the present invention to improve NV performance while ensuring drivability in a front/rear-wheel independent drive vehicle in which front-wheel and rear-wheel drive units are provided independently of each other.

The object indicated above is achieved according to the following aspects of the present invention.

According to a first aspect of the invention, there is provided a front/rear-wheel independent drive vehicle including: (a) a front-wheel drive unit including a front-side drive source configured to drive a front wheel of the vehicle and a front-side transmission mechanism disposed in a power transmission path between the front-side drive source and the front wheel and having a constant gear ratio; and (b) a rear-wheel drive unit including a rear-side drive source configured to drive a rear wheel of the vehicle and a rear-side transmission mechanism disposed in a power transmission path between the rear-side drive source and the rear wheel and having a constant gear ratio. The front-wheel drive unit and the rear-wheel drive unit are spaced apart from each other in a longitudinal direction of the vehicle, and the gear ratio of the rear-side transmission mechanism is higher than the gear ratio of the front-side transmission mechanism.

The above-described gear ratio is a ratio (= input rotational speed/output rotational speed) of an input rotational speed of the transmission mechanism to an output rotational speed of the transmission mechanism, so that, when a so-called “low gear” is established in the transmission mechanism, the gear ratio is increased whereby the output rotational speed is reduced relative to the input rotational speed.

According to a second aspect of the invention, in the front/rear-wheel independent drive vehicle according to the first aspect of the invention, each of the front-side transmission mechanism and the rear-side transmission mechanism includes at least three rotary shafts that extend substantially in parallel to a width direction of the vehicle, and a plurality of gears provided on the at least three rotary shafts, wherein the at least three rotary shafts of each of the front-side transmission mechanism and the rear-side transmission mechanism include a differential rotary shaft which is connected to a drive shaft of the vehicle in a power transmittable manner and which is provided with a final gear that is one of the plurality of gears, wherein the front-side transmission mechanism and the rear-side transmission mechanism are different from each other in terms of a tooth number ratio between the final gear and a pre-final gear which is one of the plurality of gears and which meshes with the final gear, such that the gear ratio of the rear-side transmission mechanism is different from the gear ratio of the front-side transmission mechanism.

According to a third aspect of the invention, in the front/rear-wheel independent drive vehicle according to the second aspect of the invention, a number of the at least three rotary shafts of the front-side transmission mechanism and a number of the at least three rotary shafts of the rear-side transmission mechanism are the same as each other, and a number of the plurality of gears of the front-side transmission mechanism and a number of the plurality of gears of the rear-side transmission mechanism are the same as each other, wherein a positional relationship among the at least three rotary shafts of the front-side transmission mechanism and a positional relationship among the at least three rotary shafts of the rear-side transmission mechanism are the same as each other, and a positional relationship between the plurality of gears of the front-side transmission mechanism and a positional relationship between the plurality of gears of the rear-side transmission mechanism are the same as each other, wherein the front-side transmission mechanism and the rear-side transmission mechanism are different from each other in terms of a tooth number of the final gear and a tooth number of the pre-final gear, such that the tooth number of the final gear is larger in the rear-side transmission mechanism than in the front-side transmission mechanism, and such that the tooth number of the pre-final gear is larger in the front-side transmission mechanism than in the rear-side transmission mechanism, whereby the gear ratio of the rear-side transmission mechanism is higher than the gear ratio of the front-side transmission mechanism, and wherein the front-side transmission mechanism and the rear-side transmission mechanism are the same as each other in terms of a tooth number of each of other of the plurality of gears that is other than the final gear and the pre-final gear.

According to a fourth aspect of the invention, in the front/rear-wheel independent drive vehicle according to the third aspect of the invention, each of the front-side drive source and the rear-side drive source includes an output shaft extending in the width direction of the vehicle and disposed on a first axis that is substantially parallel to the width direction of the vehicle, wherein the at least three rotary shafts of each of the front-side transmission mechanism and the rear-side transmission mechanism include an input rotary shaft, an intermediate rotary shaft and the differential rotary shaft, wherein the input rotary shaft of each of the front-side transmission mechanism and the rear-side transmission mechanism is disposed on the first axis, and is provided with a drive gear that is one of the plurality of gears, wherein the input rotary shaft of the front-side transmission mechanism is connected to the front-side drive source in a power transmittable manner, while the input rotary shaft of the rear-side transmission mechanism is connected to the rear-side drive source in a power transmittable manner, wherein the intermediate rotary shaft of each of the front-side transmission mechanism and the rear-side transmission mechanism is disposed on a second axis that is parallel to the first axis, and is provided with the pre-final gear and a large-diameter gear that is one of the plurality of gears, such that the large-diameter gear is larger in diameter than the pre-final gear and is axially spaced apart from the pre-final gear, and such that rotation is to be transmitted to the large-diameter gear from the drive gear, and wherein the differential rotary shaft of each of the front-side transmission mechanism and the rear-side transmission mechanism, which is connected to the drive shaft, is disposed on a third axis that is parallel to the first axis, and is provided with the final gear that meshes with the pre-final gear such that rotation is to be transmitted to the final gear from the pre-final gear.

According to a fifth aspect of the invention, in the front/rear-wheel independent drive vehicle according to any one of the first through fourth aspects of the invention, there is provided a control apparatus which is configured to detect whether unevenness is present on a road surface or not, depending on whether a rotational speed of the front wheel is changed or not, wherein the control apparatus is configured, when detecting that the unevenness is present on the road surface, to limit a torque of the rear-side drive source.

According to a sixth aspect of the invention, in the front/rear-wheel independent drive vehicle according to any one of the first through fifth aspects of the invention, each of the front-side drive source and the rear-side drive source includes an electric motor, wherein the front-side drive source and the rear-side drive source are the same as each other in terms of an axial length and a diameter of a rotor of the electric motor.

In the front/rear-wheel independent drive vehicle according to any one of the first through sixth aspects of the invention, the gear ratio of the rear-side transmission mechanism is higher than the gear ratio of the front-side transmission mechanism, so that resonance is suppressed owing to difference of the gear ratio between the front-side and rear-side transmission mechanisms, namely, owing to difference of rotational speeds of various rotary parts between the front-side and rear-side transmission mechanisms, whereby NV performance can be improved and drivability such as acceleration performance can be appropriately ensured. That is, the drivability is required, in general, when the vehicle is accelerated such as upon start of running of the vehicle. When the vehicle is accelerated, a load applied to the rear wheel is increased while a load applied to the front wheel is reduced whereby a slip is likely to be caused. However, since the gear ratio of the rear-side transmission mechanism is higher than the gear ratio of the front-side transmission mechanism, a drive torque of the rear wheel is made higher than a drive torque of the front wheel, it is possible to suppress the slip, and to appropriately transmit the drive torque to the front and rear wheels thereby enabling the vehicle to sufficiently demonstrate a power performance.

In the front/rear-wheel independent drive vehicle according to the second aspect of the invention, the gear ratios of the respective front-side and rear-side transmission mechanisms are made different from each other by an arrangement in which the front-side and rear-side transmission mechanisms are different from each other in terms of the tooth number ratio between the pre-final gear and the final gear that is provided on the differential rotary shaft, so that the front-side and rear-side transmission mechanisms are made different from each other in terms of meshing frequencies of the final gear, pre-final gear and other gears that are provided to be closer to the drive source than the pre-final gear, whereby the resonance is suppressed and accordingly the NV performance can be improved.

In the front/rear-wheel independent drive vehicle according to each of the third and fourth aspects of the invention, the front-side and rear-side transmission mechanisms are the same as each other in terms of the number of the rotary shafts, the number of the gears, the positional relationship between the rotary shafts and the positional relationship between the gears. Further, the front-side and rear-side transmission mechanisms are different from each other only in terms of the number of teeth of the final gear and the number of teeth of the pre-final gear, and each of the other gears of the front-side transmission mechanism and a corresponding one of the other gears of the rear-side transmission mechanism are identical with each other. Thus, the front-wheel drive unit and the rear-wheel drive unit can be made at low cost, since they are substantially identical in construction with each other only except the final gear and pre-final gear whose numbers of teeth are different between the front-side and rear-side transmission mechanisms.

In the front/rear-wheel independent drive vehicle according to the fifth aspect of the invention, it is detected whether the unevenness is present on the road surface or not, depending on whether the rotational speed of the front wheel is changed or not, and the torque of the rear-side drive source is limited when it is detected that the unevenness is present on the road surface. Therefore, in the event of so-called “slip and grip” in which slip and grip between the rear wheel (whose drive torque is relatively large) and the road surface are alternately repeated by upward and downward displacement of the rear wheel due to the presence of the unevenness on the road surface, a shock load applied to the rear-side transmission mechanism and the rear-side drive source is reduced whereby the durability is improved. Particularly, since the detection as to whether the unevenness is present on the road surface or not is made depending on change of the rotational speed of the front wheel that enters into a wave-like road before the rear wheel, it is possible to appropriately reduce the shock load due to the slip and grip of the rear wheel that enters into the wave-like road after the front wheel.

In the front/rear-wheel independent drive vehicle according to the sixth aspect of the invention, the front-side and rear-side drive sources are constituted by the respective electric motors that are the same as each other in terms of the axial length and diameter of the rotor, so that the electric motors of the respective front-side and rear-side drive sources are the same as each other in terms of an inertia torque as long as there is no difference of rotational speed change therebetween. However, since the gear ratio of the rear-side transmission mechanism is higher than the gear ratio of the front-side transmission mechanism, the rotational speed change of the electric motor of the rear-side drive source is made larger than that of the electric motor of the front-side drive source, so that the inertia torque of the electric motor of the rear-side drive source is made larger and accordingly the shock load applied to the electric motor of the rear-side drive source is made larger in the event of the slip and grip. The shock load applied to the electric motor of the rear-side transmission mechanism can be appropriately reduced, for example, by limiting the torque of the rear-side drive source depending on the rotational speed change of the front wheel as in the above-described fifth aspect of the invention. Further, since the electric motor has a high responsiveness to a torque control, the shock load applied to the rear-side transmission mechanism can be more appropriately reduced by limiting the torque of the rear-side drive source depending on the rotational speed change of the front wheel.

### BRIEF DESCRIPTION OF THE DRAWINGS

FIG. 1 is a plan view schematically showing drive units provided in respective front and rear portions of an electric vehicle as an embodiment of the present invention;

FIG. 2 is a view schematically showing a construction of the front-wheel drive unit provided in the electric vehicle of FIG. 1, wherein the view is a cross-sectional view obtained by cutting the electric drive unit in a width direction of the vehicle and unfolding the cross-sectional view such that a plurality of axes Sf1-Sf3 lie on a single plain;

FIG. 3 is a view schematically showing a construction of the rear-wheel drive unit provided in the electric vehicle of FIG. 1, wherein the view is a cross-sectional view obtained by cutting the electric drive unit in the width direction of the vehicle and unfolding the cross-sectional view such that a plurality of axes Sr1-Sr3 lie on a single plain; and

FIG. 4 is a view for explaining an operation of a torque limiting control portion that is functionally included in an electronic control apparatus of the electric vehicle shown in FIG. 1, wherein the operation is made when the vehicle runs on a wave-like road in which unevenness with bumps is present on a surface of the road.

### DETAILED DESCRIPTION OF PREFERRED EMBODIMENT

In the present invention, the front/rear-wheel independent drive vehicle is constituted advantageously by, for example, an electrically operated vehicle including electric motors as the front-side and rear-side drive sources. However, the present invention is applicable also to an engine drive vehicle including only engines (internal combustion engines) as the drive sources. The electric motor may be a motor generator having also a function serving as an electric power generator. The electric motor may be a hybrid electric vehicle including only the electric motors as the drive sources, or a hybrid-type electrically operated vehicle including the electric motor and the engine as the drive sources. The front-side and rear-side drive sources are preferably the same in kind and torque characteristics as each other, but may be different from each other in the torque characteristics, for example. Where the front-side and rear-side drive sources are constituted by the respective electric motors, for example, the electric motors may be either the same as each other or different from each other in terms of an axial length and a diameter of a rotor of each electric motor. The front-side and rear-side drive sources may be disposed transversely with the respective output shafts extending substantially parallel to the width direction of the vehicle, such that the front-side and rear-side drive sources have the same attitudes facing the same direction that is one of widthwise opposite directions parallel to the width direction of the vehicle, or such that the front-side and rear-side drive sources have symmetrical attitudes facing the widthwise opposite directions. Further, the front-wheel and rear-wheel drive units (each including the transmission mechanism as well as the drive source) may be disposed to have symmetrical attitudes facing the widthwise opposite directions. Moreover, the front-side and rear-side drive sources may be disposed longitudinally with the respective output shafts extending substantially parallel to a longitudinal direction of the vehicle, and the front-side and rear-side transmission mechanisms may be disposed longitudinally with the rotary shafts extending substantially parallel to the longitudinal direction of the vehicle. The present invention is applied advantageously to a four-wheel drive vehicle including front left and right wheels and rear left and right wheels. However, the present invention is applicable to any kinds of the front/rear-wheel independent drive vehicle such as a three-wheel drive vehicle including either a single front wheel and rear left and right wheels or a single rear wheel and front left and right wheels.

Each of the front-side and rear-side transmission mechanisms may be constituted by a gear type transmission such as a planetary gear set and a standard gear set consisting of external gears. However, each of the transmission mechanisms may be constituted by any of other type transmissions such as a chain-belt type transmission. Further, each of the transmission mechanisms may be either a speed reducer having a constant gear ratio that is higher than one, or a speed increaser having a constant gear ratio that is lower than one. The gears included in each of the transmission mechanisms are provided on the rotary shafts. However, in addition to the gears provided on the rotary shafts, it is also possible to employ, for example, a ring gear of the planetary gear set (constituting the transmission mechanism) which is unrotatably fixed to a casing or the like. Where the rotary shafts of each of the transmission mechanisms include three rotary shafts consisting of the input rotary shaft connected to the corresponding drive source, the intermediate rotary shaft and the differential rotary shaft connected to the drive shaft, the rotary shafts may further include at least one another intermediate rotary shaft. Further, the rotary shafts may include only two rotary shafts consisting of the input rotary shaft and the differential rotary shaft, without including the intermediate rotary shaft. The input rotary shaft and the differential rotary shaft are disposed on respective axes which are different from each other and which are parallel to each other, for example. However, the input rotary shaft and the differential rotary shaft may be disposed on a common axis, for example, with a planetary gear transmission being used to constitute the transmission mechanism and a differential device. Although each of the gears included in the transmission mechanisms is preferably a helical gear having a tooth form generated on a helical path about its axis, it may be a spur gear having a tooth form parallel to its axis.

Where the rotary shafts of each of the transmission mechanisms include three or more rotary shafts, it is preferable that the front-side and rear-side transmission mechanisms are different from each other in terms of a tooth number of the pre-final gear and/or the final gear that is provided on the differential rotary shaft, and also in terms of a tooth number ratio between the pre-final gear and the final gear, such that the gear ratio of the rear-side transmission mechanism is higher than the gear ratio of the front-side transmission mechanism. However, the front-side and rear-side transmission mechanisms may be made different from each other in terms of the gear ratio, by making a tooth number of other gear or gears (that are provided to be closer to the drive source than the pre-final gear) different between the front-side and rear-side transmission mechanisms, or by making a tooth number of three or more gears different between the front-side and rear-side transmission mechanisms.

In the front/rear-wheel independent drive vehicle according to the present invention, it is preferable that whether the unevenness is present on the road surface or not is detected depending on whether the rotational speed of the front wheel is changed or not, and that the torque of the rear-side drive source is limited when it is detected that the unevenness is present on the road surface. However, a torque of the front-side drive source as well as the torque of the rear-side drive source may be limited. Further, the detection of presence of the unevenness on the road surface may be made based on the rotational speed change of the rear wheel in place of the rotational speed change of the front wheel, or based on both of the rotational speed change of the front wheel and the rotational speed change of the rear wheel. The rotational speed change of each wheel may be detected by detecting the rotational speed change of the wheel itself. However, since the rotational speed of any one of the rotary shafts of the transmission mechanism such as the differential rotary shaft, by which the power is to be distributed to the left or right wheel, is changed together with the rotational speed change of the wheel, it is also possible to detect the presence of the unevenness on the road surface, based on change of the rotational speed of any one of the rotary shafts. The detection of the presence of the unevenness on the road surface may be made, for example, depending on whether an absolute value of a rotational acceleration that corresponds to a rate of change of the rotational speed becomes equal to or higher than a determination threshold value. However, the detection may be made in any one of various manners such as a manner in which the detection is made based on an amplitude or a cycle of periodic change of the rotational speed. Further, the detection may be made based on, for example, an acceleration of a vertical displacement of the vehicle or any other variable (physical quantity) other than the rotational speed. It is noted that provision of the control apparatus configured to execute an operation for controlling the torque of the drive source is not essential, so that the present invention can be carried out even without such a control apparatus.

### Embodiment

There will be described an embodiment of the present invention in details with reference to drawings. It is noted that figures of the drawings are simplified or deformed as needed, and each portion is not necessarily precisely depicted in terms of dimension ratio, shape, angle, etc.

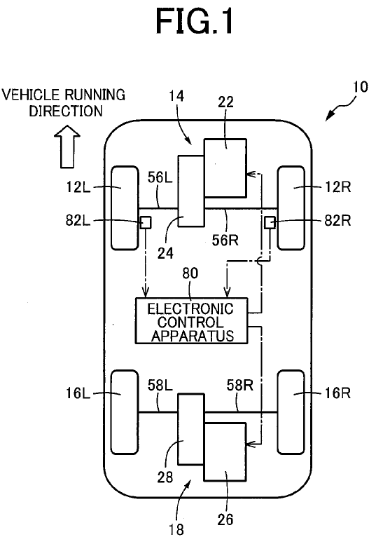

FIG. 1 is a plan view schematically showing drive units provided in an electric vehicle 10 as a front/rear-wheel independent drive vehicle, which is constructed according to an embodiment of the present invention. The electric vehicle 10 includes a front-wheel drive unit 14 provided in a front portion of the vehicle 10 and configured to drive and rotate front left and right wheels 12L, 12R of the vehicle 10, and a rear-wheel drive unit 18 provided in a rear portion of the vehicle 10 and configured to drive and rotate rear left and right wheels 16L, 16R of the vehicle 10, such that the front-wheel drive unit 14 and the rear-wheel drive unit 18 are spaced apart from each other independently of each other. Although the electric vehicle 10 is driven to run, for example, with only an onboard battery serving as an electric power source, the electric vehicle 10 may be provided with an electric power generator such as fuel cell.

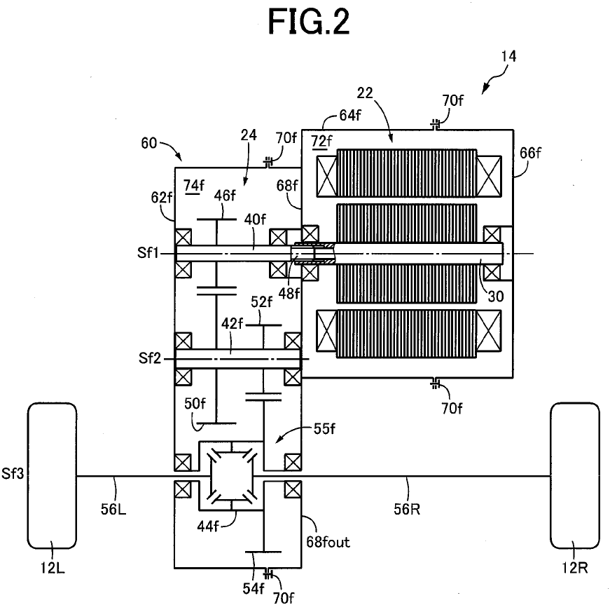

FIG. 2 is a view schematically showing a construction of the front-wheel drive unit 14, wherein the view is a cross-sectional view obtained by cutting the front-wheel drive unit 14 in a width direction of the vehicle 10 (hereinafter referred to as “vehicle width direction”) and unfolding the cross-sectional view such that first through third axes Sf1-Sf3 lie on a single plain. The first through third axes Sf1-Sf3 are axes on which a plurality of shafts are disposed. The first through third axes Sf1-Sf3 are parallel to one another. The front-wheel drive unit 14 is disposed in the electric vehicle 10, to have an attitude that makes the first through third axes Sf1-Sf3 substantially parallel to the vehicle width direction. The front-wheel drive unit 14 includes a front-side MG 22 as a front-side drive source and a gear-type front-side transmission mechanism 24 which is provided in a power transmission path between the front-side MG 22 and the front left and right wheels 12L, 12R and which has a constant gear ratio γf (> 1). The front-side MG 22 is a motor generator serving as a selected one of an electric motor and an electric power generator. The front-side MG 22 is disposed transversely such that its output shaft in the form of an MG shaft 30 is located on the first axis Sf1. In the present embodiment, the front-side MG 22 is disposed to have a leftward attitude, and is housed together with the front-side transmission mechanism 24 within a common casing 60, wherein the front-side transmission mechanism 24 is contiguous with the front-side MG 22 and is located on a left side of the front-side MG 22.

The front-side transmission mechanism 24 includes the plurality of shafts in the form of three rotary shafts consisting of an input rotary shaft 40f, an intermediate rotary shaft 42f and a differential rotary shaft 44f. The input rotary shaft 40f is disposed on the first axis Sf1, and is provided with a drive gear 46f and splines 48f. The input rotary shaft 40f is connected through the splines 48f to the MG shaft 30 of the front-side MG 22 in a power transmittable manner. The intermediate shaft 42f is disposed on the second axis Sf2 parallel to the first axis Sf1, and is provided with a large-diameter gear 50f and a pre-final gear 52f that are axially spaced apart from each other. The large-diameter gear 50f and the above-described drive gear 46f mesh with each other so as to transmit rotation therebetween. The pre-final gear 52f has a diameter smaller than the large-diameter gear 50f. The differential rotary shaft 44f is disposed on the third axis Sf3 parallel to the first axis Sf1, and is connected to each of front-wheel drive shafts 56L, 56R through splines or the like in a power transmittable manner. The differential rotary shaft 44f is provided with a final gear 54f. The final gear 54f and the above-described pre-final gear 52f mesh with each other so as to transmit rotation therebetween.

The differential rotary shaft 44f includes a differential casing of a differential device 55f including bevel gears. The final gear 54f, which is disposed on the differential rotary shaft 44f, has a larger diameter and a larger number of teeth than the pre-final gear 52f, so that the differential rotary shaft 44f is to be rotated at a rotational speed lower than the intermediate shaft 42f. The differential rotary shaft 44f distributes a power to the front-left-and-right-wheel drive shafts 56L, 56R. The rotation outputted by the front-side MG 22 is decelerated by the front-side transmission mechanism 24 serving as a transaxle, and is transmitted to the front-left-and-right-wheel drive shafts 56L, 56R whereby the front left and right wheels 12L, 12R are driven and rotated with a rotational speed difference between the front left and right wheels 12L, 12R being allowed. The front-side transmission mechanism 24 is a speed reducer having the gear ratio γf that is larger than 1 (γf > 1), wherein the gear ratio γf is defined as a ratio [ωfi/ωfo] of an input rotational speed ωfi of the front-side transmission mechanism 24 to an output rotational speed ωfo of the front-side transmission mechanism 24. The input rotational speed ωfi is a rotational speed of the input rotary shaft 40f, while the output rotational speed ωfo is a rotational speed of the differential rotary shaft 44f. It is noted that a constant-velocity joint or the like is provided, as needed, between the differential device 55f and each of the front-wheel drive shafts 56L, 56R, and between each of the front-wheel drive shafts 56L, 56R and a corresponding one of the front wheels 12L, 12R. It is also noted that, while the front-wheel drive unit 14 is disposed on a front side of the front-wheel drive shafts 56L, 56R in a vehicle running direction in an example shown in FIG. 1, the front-wheel drive unit 14 may be disposed on an upper side (corresponding to a top side of drawing sheet of FIG. 1) of the front-wheel drive shafts 56L, 56R or on a rear side of the front-wheel drive shafts 56L, 56R in the vehicle running direction.

The casing 60 is constituted by three casing member 62f, 64f, 66f which are arranged in the vehicle width direction and which are fixed to each other. Each adjacent pair of the three casing members 62f, 64f, 66f are in contact in their outer peripheral end portions with each other, and are fixed to each other by a plurality of bolts 70f. The casing member 64f, which is an intermediate one among the three casing members 62f, 64f, 66f, is provided integrally with a partition wall 68f that extends inwardly in a direction substantially perpendicular to the axes Sf1-Sf3, such that an MG housing space 72f is defined by cooperation of the casing member 66f and the partition wall 68f. The front-side MG 22 is housed in the MG housing space 72f. An outer wall 68f out is provided to be contiguous with the partition wall 68f, and the outer wall 68f out and the partition wall 68f cooperate with the casing member 62f to define a gear housing space 74f in which the front-side transmission mechanism 24 is housed. For cooling the front-side MG 22 and lubricating the gears 46f, 50f, 52f, 54f and bearings, lubricant oil is supplied to the housing spaces 72f, 74f through lubrication circuit (not shown). The housing spaces 72f, 74f are held in communication with each other through cutouts, communication holes or the like, so that the lubricant oil can be distributed.

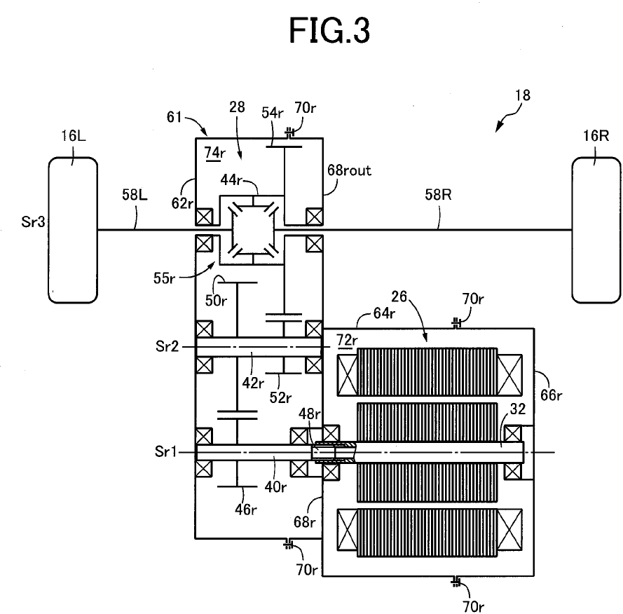

FIG. 3 is a view schematically showing a construction of the rear-wheel drive unit 18, wherein the view is a cross-sectional view obtained by cutting the rear-wheel drive unit 18 in the vehicle width direction and unfolding the cross-sectional view such that first through third axes Sr1-Sr3 lie on a single plain. The first through third axes Sr1-Sr3 are axes on which a plurality of shafts are disposed. FIG. 3 is vertically inverted to FIG. 2, and the rear-wheel drive unit 18 is practically the same in construction as the above-described front-wheel drive unit 14. In the following description relating to the rear-wheel drive unit 18, the same reference numerals as in the front-wheel drive unit 14, with the letter “r” in place of the letter “f”, will be used to identify the practically corresponding elements. Further, in the following description, the letters “f′ and “r” after the reference numerals are not provided unless front and rear are to be distinguished from each other.

The first through third axes Sr1-Sr3 are parallel to one another. The rear-wheel drive unit 18 is disposed in the electric vehicle 10, to have an attitude that makes the first through third axes Sr1-Sr3 substantially parallel to the vehicle width direction. The rear-wheel drive unit 18 includes a rear-side MG 26 as a rear-side drive source and a gear-type rear-side transmission mechanism 28 which is provided in a power transmission path between the rear-side MG 26 and the rear left and right wheels 16L, 16R and which has a constant gear ratio γr (> 1). The rear-side MG 26 is a motor generator serving as a selected one of an electric motor and an electric power generator. The rear-side MG 26 is disposed transversely such that its output shaft in the form of an MG shaft 32 is located on the first axis Sr1. In the present embodiment, the rear-side MG 26 is disposed to have a leftward attitude, and is housed together with the rear-side transmission mechanism 28 within a common casing 61, wherein the rear-side transmission mechanism 28 is contiguous with the rear-side MG 26 and is located on a left side of the rear-side MG 26. The rear-side MG 26 and the front-side MG 22 are constituted by respective motor generators identical with each other and having the same standard, so that their respective rotors are the same in axial length (stack thickness), diameter and torque characteristics, for example.

The rear-side transmission mechanism 28 includes the plurality of shafts in the form of three rotary shafts consisting of an input rotary shaft 40r, an intermediate rotary shaft 42r and a differential rotary shaft 44r. The input rotary shaft 40r is disposed on the first axis Sr1, and is provided with a drive gear 46r and splines 48r. The input rotary shaft 40r is connected through the splines 48r to the MG shaft 32 of the rear-side MG 26 in a power transmittable manner. The intermediate shaft 42r is disposed on the second axis Sr2 parallel to the first axis Sr1, and is provided with a large-diameter gear 50r and a pre-final gear 52r that are axially spaced apart from each other. The large-diameter gear 50r and the above-described drive gear 46r mesh with each other so as to transmit rotation therebetween. The pre-final gear 52r has a diameter smaller than the large-diameter gear 50r. The differential rotary shaft 44r is disposed on the third axis Sr3 parallel to the first axis Sr1, and is connected to each of rear-wheel drive shafts 58L, 58R through splines or the like in a power transmittable manner. The differential rotary shaft 44r is provided with a final gear 54r. The final gear 54r and the above-described pre-final gear 52r mesh with each other so as to transmit rotation therebetween.

The differential rotary shaft 44r includes a differential casing of a differential device 55r including bevel gears. The final gear 54r, which is disposed on the differential rotary shaft 44r, has a larger diameter and a larger number of teeth than the pre-final gear 52r, so that the differential rotary shaft 44r is to be rotated at a rotational speed lower than the intermediate shaft 42r. The differential rotary shaft 44r distributes the power to the rear-left-and-right-wheel drive shafts 58L, 58R. The rotation outputted by the rear-side MG 26 is decelerated by the rear-side transmission mechanism 28 serving as a transaxle, and is transmitted to the rear-left-and-right-wheel drive shafts 58L, 58R whereby the rear left and right wheels 16L, 16R are driven and rotated with a rotational speed difference between the rear left and right wheels 16L, 16R being allowed. The rear-side transmission mechanism 28 is a speed reducer having the gear ratio γr that is larger than 1 (γr > 1), wherein the gear ratio γr is defined as a ratio [ωri/ωro] of an input rotational speed ωri of the rear-side transmission mechanism 28 to an output rotational speed ωro of the rear-side transmission mechanism 28. The input rotational speed ωri is a rotational speed of the input rotary shaft 40r, while the output rotational speed ωro is a rotational speed of the differential rotary shaft 44r. It is noted that a constant-velocity joint or the like is provided, as needed, between the differential device 55r and each of the rear-wheel drive shafts 58L, 58R, and between each of the rear-wheel drive shafts 58L, 58R and a corresponding one of the rear wheels 16L, 16R. It is also noted that, while the rear-wheel drive unit 18 is disposed on a rear side of the rear-wheel drive shafts 58L, 58R in the vehicle running direction in an example shown in FIG. 3, the rear-wheel drive unit 18 may be disposed on an upper side (corresponding to a top side of drawing sheet of FIG. 1) of the rear-wheel drive shafts 58L, 58R or on a front side of the rear-wheel drive shafts 58L, 58R in the vehicle running direction.

The casing 61 is constituted by three casing member 62r, 64r, 66r which are arranged in the vehicle width direction and which are fixed to each other. Each adjacent pair of the three casing members 62r, 64r, 66r are in contact in their outer peripheral end portions with each other, and are fixed to each other by a plurality of bolts 70r. The casing member 64r, which is an intermediate one among the three casing members 62r, 64r, 66r, is provided integrally with a partition wall 68r that extends inwardly in a direction substantially perpendicular to the axes Sr1-Sr3, such that an MG housing space 72r is defined by cooperation of the casing member 66r and the partition wall 68r. The rear-side MG 26 is housed in the MG housing space 72r. An outer wall 68r out is provided to be contiguous with the partition wall 68r, and the outer wall 68rout and the partition wall 68r cooperate with the casing member 62r to define a gear housing space 74r in which the rear-side transmission mechanism 28 is housed. For cooling the rear-side MG 26 and lubricating the gears 46r, 50r, 52r, 54r and bearings, lubricant oil is supplied to the housing spaces 72r, 74r through lubrication circuit (not shown). The housing spaces 72r, 74r are held in communication with each other through cutouts, communication holes or the like, so that the lubricant oil can be distributed.

As described above, each of the front-side and rear-side transmission mechanisms 24, 28 of the respective front-wheel and rear-wheel drive units 14, 18 includes the three rotary shafts 40, 42, 44 and the four gears 46, 50, 52, 54 provided on the three rotary shafts 40, 42, 44. The front-side and rear-side transmission mechanisms 24, 28 are the same as each other in terms of a positional relationship among the rotary shafts 40, 42, 44 and a positional relationship among the gears 46, 50, 52, 54. However, the front-side and rear-side transmission mechanisms 24, 28 are different from each other in terms of the number of teeth of the pre-final gear 52 and the number of teeth of the final gear 54. Specifically, the number Z52f of teeth of the pre-final gear 52f of the front-side transmission mechanism 24 is larger than the number Z52r of teeth of the pre-final gear 52r of the rear-side transmission mechanism 28, while the number Z54f of teeth of the final gear 54f of the front-side transmission mechanism 24 is smaller than the number Z54r of teeth of the final gear 54r of the rear-side transmission mechanism 28, so that the gear ratio γr of the rear-side transmission mechanism 28 is higher than the gear ratio γf of the front-side transmission mechanism 24. In other words, a pitch circle of the pre-final gear 52f of the front-side transmission mechanism 24 is larger in diameter than a pitch circle of the pre-final gear 52r of the rear-side transmission mechanism 28, while a pitch circle of the final gear 54f of the front-side transmission mechanism 24 is smaller in diameter than a pitch circle of the number Z54r of teeth of the final gear 54r of the rear-side transmission mechanism 28. Thus, a tooth number ratio Z52f / Z54f of the front-side transmission mechanism 24 is larger than a tooth number ratio Z52r / Z54r of the rear-side transmission mechanism 28. Since the gear ratio is increased or reduced in inverse proportion to the tooth number ratio, the gear ratio γr of the rear-side transmission mechanism 28 is made higher than the gear ratio γf of the front-side transmission mechanism 24. Regarding the drive gear 46 and the large-diameter gear 50 that are the other gears other than the pre-final gear 52 and the final gear 54, the drive gears 46f, 46r of the respective front-side and rear-side transmission mechanisms 24, 28 are identical with each other and the same as each other in terms of a number of teeth, for example, and the large-diameter gears 50f, 50r of the respective front-side and rear-side transmission mechanisms 24, 28 are identical with each other and the same as each other in terms of a number of teeth, for example. Thus, in the present embodiment, the gear ratio γr of the rear-side transmission mechanism 28 is made higher than the gear ratio γf of the front-side transmission mechanism 24, with the number Z52r of teeth of the pre-final gear 52r of the rear-side transmission mechanism 28 and the number Z52f of teeth of the pre-final gear 52f of the front-side transmission mechanism 24 being made different from each other, and with the number Z54r of teeth of the final gear 54r of the rear-side transmission mechanism 28 and the number Z54f of teeth of the final gear 54f of the front-side transmission mechanism 24 being different from each other.

Referring back to FIG. 1, the electric vehicle 10 is provided with an electronic control apparatus 80 as a control apparatus that is configured to perform various control operations including operations for controlling torques of the front-wheel drive unit 14 and the rear-wheel drive unit 18. The electronic control apparatus 80 includes a so-called microcomputer incorporating a CPU, a ROM, a RAM and an input-output interface. The CPU performs the various control operations of the electric vehicle 10, by processing various input signals, according to control programs stored in the ROM, while utilizing a temporary data storage function of the RAM. The electronic control apparatus 80 is configured to calculate a requested drive torque of each of drive wheels (the front wheels 12L, 12R and the rear wheel 16L, 16R) of the electric vehicle 10, based on, for example, a running speed V of the vehicle 10 and an accelerator opening degree θacc that represents an amount of operation of an accelerator pedal, and to calculate a front-wheel drive torque and a rear-wheel drive torque, in accordance with a predetermined torque distribution ratio. Then, the electronic control apparatus 80 is configured to calculate torque command values of the respective front-side and rear-side MGs 22, 26 that are required to realize the front-wheel and rear-wheel drive torques, based on, for example, the gear ratios γf, γr, and to control the torques of the respective front-side and rear-side MGs 22, 26 in accordance with the torque command values. The torque distribution ratio, which is a ratio of distribution of the torque of the power source, between the front wheels 12 and the rear wheels 16, may be set to a constant value such as 50:50, or set to a variable value variable depending on a running state of the electric vehicle 10 such as an acceleration and a yaw rate of the vehicle 10.

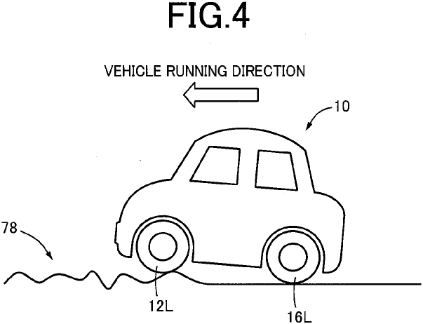

When the electric vehicle 10 enters into a wave-like road (wavy road) 78 in which unevenness with bumps is present on a surface of the road, as shown in FIG. 4, for example, each of the front wheels 12L, 12R and the rear wheel 16L, 16R is displaced upward and downward and accordingly a friction between each of the wheels 12L, 12R, 16L, 16R and the road surface is changed thereby causing so-called “slip and grip” in which slip and grip between each of the wheels 12L, 12R, 16L, 16R and the road surface are alternately repeated whereby a shock load is applied to each of the front-side and rear-side transmission mechanisms 24, 28 and front-side and rear-side MGs 22, 26. Particularly, in the present embodiment in which the gear ratio γr of the rear-wheel drive unit 18 is made high whereby a large drive torque is applied to each of the rear wheels 16L, 16R, the shock load applied to the rear-side transmission mechanism 28 is increased due to the slip and grip, and the increased shock load is likely to affect durability of the rear-side transmission mechanism 28.

However, in the present embodiment, the electronic control apparatus 80 functionally includes a torque limiting control portion which is configured to detect whether the unevenness is present on the road surface or not, and to limit the torque of the rear-side MG 26 when detecting that the unevenness is present on the road surface. In connection with the operation for controlling the torque of the rear-side MG 26, the electronic control apparatus 80 receives signals from wheel speed sensors 82L, 82R that are configured to detect rotational speeds Vwl, Vwr of the respective front left and right wheels 12L, 12R, wherein the signals represent the detected rotational speeds Vwl, Vwr. The electronic control apparatus 80 detects whether the unevenness is present on the road surface or not, depending on whether the rotational speeds Vwl, Vwr represented by the received signals are changed or not, and limits the torque of the rear-side MG 26 when detecting the unevenness is present on the road surface of the wave-like road 78, such that the torque of the rear-side MG 26 does not exceed an upper limit of the torque. In this instance, it can be determined whether the unevenness is present on the road surface or not, depending on, for example, whether an absolute value of a rotational acceleration that corresponds to a rate of change of each of the rotational speeds Vwl, Vwr becomes equal to or higher than a determination threshold value. In this determination, it may be determined that the unevenness is present on the road surface, for example, when at least one of the absolute value of the rate of change of the rotational speeds Vwl and the absolute value of the rate of change of the rotational speed Vwr exceeds the determination threshold value. Further, the determination may be made based on an average value of the rotational speeds Vwl, Vwr of the respective front left and right wheels 12L, 12R, specifically, depending on whether the absolute value of the rate of change of the average value of the rotational speeds Vwl, Vwr is equal to or higher than a determination threshold value. It is noted that the torque of the front-side MG 22 as well as the torque of the rear-side MG 26 may be limited when it is determined that the unevenness is present on the road surface.

As described above, in the electric vehicle 10 as the front/rear-wheel independent drive vehicle, the gear ratio γr of the rear-side transmission mechanism 28 is higher than the gear ratio γf of the front-side transmission mechanism 24, so that resonance is suppressed owing to the difference of the gear ratio γ between the front-side and rear-side transmission mechanisms 24, 28, namely, owing to difference of rotational speeds of various rotary parts between the front-side and rear-side transmission mechanisms 24, 28, whereby NV performance can be improved and drivability such as acceleration performance can be appropriately ensured. In general, the drivability is required when the electric vehicle 10 is accelerated such as upon start of running of the vehicle 10. When the vehicle 10 is accelerated, the load applied to each of the rear wheels 16L, 16R is increased while the load applied to each of the front wheels 12L, 12R is reduced whereby the slip is likely to be caused. However, since the gear ratio γr of the rear-side transmission mechanism 28 is higher than the gear ratio γf of the front-side transmission mechanism 24, the drive torque of each of the rear wheels 16L, 16R is made higher than the drive torque of each of the front wheels 12L, 12R, it is possible to suppress the slip, and to appropriately transmit the drive torques to the front and rear wheels 12L, 12R, 16L, 16R thereby enabling the vehicle 10 to sufficiently demonstrate the power performance.

Further, the gear ratios γf, γr of the respective front-side and rear-side transmission mechanisms 24, 28 are made different from each other by the arrangement in which the front-side and rear-side transmission mechanisms 24, 28 are different from each other in terms of the tooth number ratio Z52 / Z54 between the pre-final gear 52 and the final gear 54 that is provided on the differential rotary shaft 44, so that the front-side and rear-side transmission mechanisms 24, 28 are made different from each other in terms of meshing frequencies of the final gear 54, pre-final gear 52 and other gears 46, 50 that are provided to be closer to the drive source (MG) than the pre-final gear 52, whereby the resonance is suppressed and accordingly the NV performance can be improved.

Further the front-side and rear-side transmission mechanisms 24, 28 are the same as each other in terms of the number of the rotary shafts 40, 42, 44, the number of the gears 46, 50, 52, 54, the positional relationship among the rotary shafts 40, 42, 44 and the positional relationship among the gears 46, 50, 52, 54. Further, the front-side and rear-side transmission mechanisms 24, 28 are different from each other only in terms of the number of teeth of the final gear 54 and the number of teeth of the pre-final gear 52, and each of the other gears 46, 50 of the front-side transmission mechanism 24 and a corresponding one of the other gears 46, 50 of the rear-side transmission mechanism 28 are identical with each other. Thus, the front-wheel drive unit 14 and the rear-wheel drive unit 18 can be made at low cost, since they are substantially identical in construction with each other only except the final gear 54 and pre-final gear 52 whose numbers of teeth are different between the front-side and rear-side transmission mechanisms 24, 28.

Further, it is detected whether the unevenness is present on the road surface or not, depending on whether the rotational speeds Vwl, Vwr of the front wheels 12L, 12R are changed or not, and the torque of the rear-side MG 26 is limited to the upper limit, when it is detected that the unevenness is present on the road surface. Therefore, in the event of the slip and grip in which slip and grip between the rear wheels 16L, 16R (whose drive torque is relatively large) and the road surface are alternately repeated by upward and downward displacements of the rear wheels 16L, 16R due to the presence of the unevenness on the road surface, the shock load applied to the rear-side transmission mechanism 28 and the rear-side MG 26 is reduced whereby the durability is improved. Particularly, since the detection as to whether the unevenness is present on the road surface or not is made depending on the change of the rotational speeds of the front wheels 12L, 12R that enter into the wave-like road 78 before the rear wheels 16L, 16R, it is possible to appropriately reduce the shock load due to the slip and grip of the rear wheels 16L, 16r that enter into the wave-like road 78 after the front wheels 12L, 12R.

Further, the front-side MG 22 and the rear-side MG 26 are constituted by the respective motor generators that are the same as each other in terms of the axial length and diameter of the rotor, so that the front-side MG 22 and the rear-side MG 26 are the same as each other in terms of an inertia torque as long as there is no difference of rotational speed change therebetween. However, since the gear ratio γr of the rear-side transmission mechanism 28 is higher than the gear ratio γf of the front-side transmission mechanism 24, the rotational speed change of the rear-side MG 26 is made larger than that of the front-side MG 22, so that the inertia torque of the rear-side MG 26 is made larger and accordingly the shock load applied to the rear-side MG 26 is made larger in the event of the slip and grip. The shock load applied to the rear-side transmission mechanism 28 can be appropriately reduced by limiting the torque of the rear-side MG 26 to the upper limit, depending on the rotational speed change of the front wheels 12L, 12R. Further, since the rear-side MG 26 as the motor generator has a high responsiveness to the torque control, the shock load applied to the rear-side transmission mechanism 28 can be more appropriately reduced by limiting the torque of the rear-side MG 26 depending on the rotational speed change of the front wheels 12L, 12R.

It is to be understood that the embodiment described above is given for illustrative purpose only, and that the present invention may be embodied with various modifications and improvements which may occur to those skilled in the art.

Nomenclature of Elements

| | |
|---|---|
| 10: | electric vehicle (front/rear-wheel independent drive vehicle) |
| 12L,12R: | front wheel |
| 14: | front-wheel drive unit |
| 16L, 16R: | rear wheel |
| 18: | rear-wheel drive unit |
| 22: | front-side MG (front-side drive source, electric motor) |
| 24: | front-side transmission mechanism |
| 26: | rear-side MG (rear-side drive source, electric motor) |
| 28: | rear-side transmission mechanism |
| 30, 32: | MG shaft (output shaft) |
| 40f, 40r: | input rotary shaft (rotary shaft) |
| 42f, 42r: | intermediate rotary shaft (rotary shaft) |
| 44f, 44r: | differential rotary shaft (rotary shaft) |
| 46f, 46r: | drive gear (gear) |
| 50f, 50r: | large-diameter gear (gear) |
| 52f, 52r: | pre-final gear (gear) |
| 54f, 54r: | final gear (gear) |
| 56L, 56R: | front-wheel drive shaft |
| 58L, 58R: | rear wheel drive shaft |
| 80: | electronic control apparatus (control apparatus) |
| Sf1, Sr1: | first axis |
| Sf2, Sr2: | second axis |
| Sf3, Sr3: | third axis |

What is claimed is:

1. A front/rear-wheel independent drive vehicle comprising:
a front-wheel drive unit including a front-side drive source configured to drive a front wheel of the vehicle and a front-side transmission mechanism disposed in a power transmission path between the front-side drive source and the front wheel and having a constant gear ratio; and
a rear-wheel drive unit including a rear-side drive source configured to drive a rear wheel of the vehicle and a rear-side transmission mechanism disposed in a power transmission path between the rear-side drive source and the rear wheel and having a constant gear ratio,
wherein the front-wheel drive unit and the rear-wheel drive unit are spaced apart from each other in a longitudinal direction of the vehicle, and
wherein the gear ratio of the rear-side transmission mechanism is higher than the gear ratio of the front-side transmission mechanism.

2. The front/rear-wheel independent drive vehicle according to claim 1,
wherein each of the front-side transmission mechanism and the rear-side transmission mechanism includes at least three rotary shafts that extend substantially in parallel to a width direction of the vehicle, and a plurality of gears provided on the at least three rotary shafts,
wherein the at least three rotary shafts of each of the front-side transmission mechanism and the rear-side transmission mechanism include a differential rotary shaft which is connected to a drive shaft of the vehicle in a power transmittable manner and which is provided with a final gear that is one of the plurality of gears, and
wherein the front-side transmission mechanism and the rear-side transmission mechanism are different from each other in terms of a tooth number ratio between the final gear and a pre-final gear which is one of the plurality of gears and which meshes with the final gear, such that the gear ratio of the rear-side transmission mechanism is different from the gear ratio of the front-side transmission mechanism.

3. The front/rear-wheel independent drive vehicle according to claim 2,
wherein a number of the at least three rotary shafts of the front-side transmission mechanism and a number of the at least three rotary shafts of the rear-side transmission mechanism are the same as each other, and a number of the plurality of gears of the front-side transmission mechanism and a number of the plurality of gears of the rear-side transmission mechanism are the same as each other,
wherein a positional relationship among the at least three rotary shafts of the front-side transmission mechanism and a positional relationship among the at least three rotary shafts of the rear-side transmission mechanism are the same as each other, and a positional relationship between the plurality of gears of the front-side transmission mechanism and a positional relationship between the plurality of gears of the rear-side transmission mechanism are the same as each other,
wherein the front-side transmission mechanism and the rear-side transmission mechanism are different from each other in terms of a tooth number of the final gear and a tooth number of the pre-final gear, such that the tooth number of the final gear is larger in the rear-side transmission mechanism than in the front-side transmission mechanism, and such that the tooth number of the pre-final gear is larger in the front-side transmission mechanism than in the rear-side transmission mechanism, whereby the gear ratio of the rear-side transmission mechanism is higher than the gear ratio of the front-side transmission mechanism, and
wherein the front-side transmission mechanism and the rear-side transmission mechanism are the same as each other in terms of a tooth number of each of other of the plurality of gears that is other than the final gear and the pre-final gear.

4. The front/rear-wheel independent drive vehicle according to claim 3,
wherein each of the front-side drive source and the rear-side drive source includes an output shaft extending in the width direction of the vehicle and disposed on a first axis that is substantially parallel to the width direction of the vehicle,
wherein the at least three rotary shafts of each of the front-side transmission mechanism and the rear-side transmission mechanism include an input rotary shaft, an intermediate rotary shaft and the differential rotary shaft,
wherein the input rotary shaft of each of the front-side transmission mechanism and the rear-side transmission mechanism is disposed on the first axis, and is provided with a drive gear that is one of the plurality of gears,
wherein the input rotary shaft of the front-side transmission mechanism is connected to the front-side drive source in a power transmittable manner, while the input rotary shaft of the rear-side transmission mechanism is connected to the rear-side drive source in a power transmittable manner,
wherein the intermediate rotary shaft of each of the front-side transmission mechanism and the rear-side transmission mechanism is disposed on a second axis that is parallel to the first axis, and is provided with the pre-final gear and a large-diameter gear that is one of the plurality of gears, such that the large-diameter gear is larger in diameter than the pre-final gear and is axially spaced apart from the pre-final gear, and such that rotation is to be transmitted to the large-diameter gear from the drive gear, and
wherein the differential rotary shaft of each of the front-side transmission mechanism and the rear-side transmission mechanism, which is connected to the drive shaft, is disposed on a third axis that is parallel to the first axis, and is provided with the final gear that meshes with the pre-final gear such that rotation is to be transmitted to the final gear from the pre-final gear.

5. The front/rear-wheel independent drive vehicle according to claim 1, comprising a control apparatus which is configured to detect whether unevenness is present on a road surface or not, depending on whether a rotational speed of the front wheel is changed or not,
wherein the control apparatus is configured, when detecting that the unevenness is present on the road surface, to limit a torque of the rear-side drive source.

6. The front/rear-wheel independent drive vehicle according to claim 1,
wherein each of the front-side drive source and the rear-side drive source includes an electric motor, and
wherein the front-side drive source and the rear-side drive source are the same as each other in terms of an axial length and a diameter of a rotor of the electric motor.
